(19) United States
(12) Patent Application Publication
(10) Pub. No.: US 2024/0427162 A1
(43) Pub. Date: Dec. 26, 2024

(54) SPECIALIZED RETICLE FOR VIEWING OPTIC

(71) Applicant: Sheltered Wings, Inc. d/b/a Vortex Optics, Barneveld, WI (US)

(72) Inventors: David Hamilton, Barneveld, WI (US); Michael Rosen, Barneveld, WI (US)

(21) Appl. No.: 18/824,486

(22) Filed: Sep. 4, 2024

Related U.S. Application Data
(63) Continuation of application No. 18/337,856, filed on Jun. 20, 2023, now abandoned.
Application No. 18/337,856 is a continuation of application No. 17/929,904, filed on Sep. 6, 2022, now abandoned.
Application No. 17/929,904 is a continuation of application No. 16/532,964, filed on Aug. 6, 2019, now abandoned.
(60) Provisional application No. 62/715,374, filed on Aug. 7, 2018.

(51) Int. Cl. G02B 27/32; F41G 1/38

(52) U.S. Cl. CPC G02B 27/32; F41G 1/38

(57) ABSTRACT

A reticle has a horizontal stadia line and a vertical stadia line. A plurality of elevation subtension markings having a thickness are connected to the vertical stadia line. A plurality of fine subtension markings are positioned along the horizontal stadia line. A plurality of coarse subtension markings are positioned along the horizontal stadia line. The thickness of the coarse subtension markings is greater than the thickness of the fine subtension markings. A Christmas tree dot pattern is provided below the horizontal stadia line with a hold point feature within a lower portion of the Christmas tree dot pattern.

### CROSS-REFERENCE TO RELATED APPLICATION

This application is a continuation patent application of U.S. patent application Ser. No. 18/337,856 filed Jun. 20, 2023, which is a continuation patent application of U.S. patent application Ser. No. 17/929,904 filed Sep. 6, 2022, which is a continuation patent application of U.S. patent application Ser. No. 16/532,964 filed Aug. 6, 2019, which claims priority to and is a non-provisional patent application of U.S. Provisional Application No. 62/715,374 filed Aug. 7, 2018, which is incorporated herein by reference in its entirety.

### FIELD

The disclosure relates to reticles for optical sighting devices, and more particularly to a reticle for large zoom range optical sighting devices.

### BACKGROUND

As technology advances, the ability of optical sighting devices to achieve higher magnifications, i.e., greater zoom, has improved. The magnification capability of some optical sighting devices ranges from 1× to 4×, or 6×, or 8×, or even 10×, with the potential for greater magnification as technology is refined. It will be appreciated that the functionality of a reticle must be maintained across the magnification range.

Previous reticle designs, which use thin metal sheets cut into the desired reticle pattern, i.e., “wire reticles,” are not suitable for use over a wide range of magnifications, i.e., from 1× up to 10×. Wire reticles are very susceptible to breaking and are limited in design due to the manufacturing method and structure of the wire reticles. Wire reticles generally cannot contain numbers or long cantilevered details. One of the biggest drawbacks to wire reticles is the inability to have unsupported or “floating” features.

Accordingly, the need exists for a reticle which contains detailed and complex features to facilitate functionality over a range of magnifications, i.e., 1× to 10× or greater.

### SUMMARY

In one embodiment, the disclosure provides a reticle. In accordance with the embodiments of the disclosure, the reticle comprises: a horizontal stadia line and a vertical stadia line; a plurality of elevation subtension markings having a thickness and are connected to the vertical stadia line; a plurality of fine subtension markings positioned along the horizontal stadia line and having a thickness; a plurality of coarse subtension markings positioned along the horizontal stadia line and having a thickness greater than the thickness of the fine subtension markings; a Christmas tree dot pattern below the horizontal stadia line; and a hold point feature within the Christmas tree dot pattern at a lower portion of the Christmas tree dot pattern.

In another embodiment, the disclosure provides an optical sighting device. In accordance with embodiments of the disclosure, the optical sighting device comprises: a body with a first end and a second end having a center axis; an objective lens system disposed within the body; an erector lens system disposed within the body; the objective lens system, eyepiece lens, and erecter lens system forming an optical system having a first focal plane and a second focal plane, the first focal plane proximate the objective lens system and the second focal plane proximate the eyepiece lens; a first reticle at the first focal plane; the first reticle including a horizontal stadia line and a vertical stadia line; the first reticle further including a plurality of elevation subtension markings having a thickness and are connected to the vertical stadia line; the first reticle further including a plurality of fine subtension markings positioned along the horizontal stadia line and having a thickness; the first reticle further including a plurality of coarse subtension markings positioned along the horizontal stadia line and having a thickness greater than the thickness of fine subtension markings; the first reticle further comprising a Christmas tree dot pattern below the horizontal stadia line; and the first reticle further comprising a hold point feature within the Christmas tree dot pattern at a lower portion of the Christmas tree dot pattern.

Other embodiments will be evident from a consideration of the drawings taken together with the detailed description of the disclosure.

### BRIEF DESCRIPTION OF THE DRAWINGS

FIG. 1 is a perspective view of a riflescope optical sighting device in accordance with the disclosure.

FIG. 2 is a cross-section view of the riflescope of FIG. 1 along line 2-2, showing a moveable optical element inside the scope body.

FIG. 3 is a schematic view of the erector system in the optical element of an optical sighting device in accordance with the disclosure.

FIG. 4A is a view through one embodiment of a prior art first focal plane reticle as viewed at a lower magnification setting.

FIG. 4B is a view through the first focal plane reticle of FIG. 4A as viewed at a higher magnification setting.

FIG. 5A is a view through one embodiment of a prior art first focal plane reticle as viewed at a lower magnification setting.

FIG. 5B is a view through the first focal plane reticle of FIG. 5A as viewed at a higher magnification setting.

FIG. 6 is a view through one embodiment of a first focal plane reticle in accordance with the disclosure.

FIG. 7 is a view through the first focal plane reticle of FIG. 6 as viewed at a lower magnification setting.

### DEFINITIONS

The numerical ranges in this disclosure are approximate, and thus may include values outside of the range unless otherwise indicated. Numerical ranges include all values from and including the lower and the upper values, in increments of one unit, provided that there is a separation of at least two units between any lower value and any higher value. As an example, if a compositional, physical or other property, such as, for example, molecular weight, viscosity, etc., is from 100 to 1,000, it is intended that all individual values, such as 100, 101, 102, etc., and sub ranges, such as 100 to 144, 155 to 170, 197 to 200, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure. Numerical ranges are provided within this disclosure for, among other things, distances from a user of a device to a target or from a first component of a device to a second component of a device.

The term “and/or” as used in a phrase such as “A and/or B” herein is intended to include both A and B; A or B; A (alone); and B (alone). Likewise, the term “and/or” as used in a phrase such as “A, B, and/or C” is intended to encompass each of the following embodiments: A, B, and C; A, B, or C; A or C; A or B; B or C; A and C; A and B; B and C; A (alone); B (alone); and C (alone).

As used herein, a “firearm” is a portable gun, being a barreled weapon that launches one or more projectiles often driven by the action of an explosive force. As used herein, the term “firearm” includes a handgun, a long gun, a rifle, shotgun, a carbine, automatic weapons, semi-automatic weapons, a machine gun, a sub-machine gun, an automatic rifle, and an assault rifle.

As used herein, the term “Christmas tree pattern” refers to a pattern where there are fewer markings in a horizontal fashion or horizontal linear direction below the primary horizontal stadia line and more markings in a horizontal fashion or linear direction as you move farther from the primary horizontal stadia line.

As used herein, the term “viewing optic” refers to an apparatus used by a shooter or a spotter to select, identify or monitor a target. The “viewing optic” may rely on visual observation of the target, or, for example, on infrared (IR), ultraviolet (UV), radar, thermal, microwave, or magnetic imaging, radiation including X-ray, gamma ray, isotope and particle radiation, night vision, vibrational receptors including ultra-sound, sound pulse, sonar, seismic vibrations, magnetic resonance, gravitational receptors, broadcast frequencies including radio wave, television and cellular receptors, or other image of the target. The image of the target presented to the shooter by the “viewing optic” device may be unaltered, or it may be enhanced, for example, by magnification, amplification, subtraction, superimposition, filtration, stabilization, template matching, or other means. The target selected, identified or monitored by the “viewing optic” may be within the line of sight of the shooter, or tangential to the sight of the shooter, or the shooter's line of sight may be obstructed while the target acquisition device presents a focused image of the target to the shooter. The image of the target acquired by the “viewing optic” may be, for example, analog or digital, and shared, stored, archived, or transmitted within a network of one or more shooters and spotters by, for example, video, physical cable or wire, IR, radio wave, cellular connections, laser pulse, optical, 802.11b or other wireless transmission using, for example, protocols such as html, SML, SOAP, X.25, SNA, etc., Bluetooth™, Serial, USB or other suitable image distribution method. The term “viewing optic” is used interchangeably with “optic sight.”

As used herein, the term “shooter” applies to either the operator making the shot or an individual observing the shot in collaboration with the operator making the shot.

### DETAILED DESCRIPTION

The apparatuses and methods disclosed herein will now be described more fully hereinafter with reference to the accompanying drawings, in which embodiments of the disclosure are shown. The apparatuses and methods disclosed herein may, however, be embodied in many different forms and should not be construed as limited to the embodiments set forth herein. Rather, these embodiments are provided so that the disclosure will be thorough and complete and will fully convey the scope of the invention to those skilled in the art.

It will be appreciated by those skilled in the art that the set of features and/or capabilities may be readily adapted within the context of a standalone weapons sight, front-mount or rear-mount clip-on weapons site, and other permutations of filed deployed optical weapons sights. Further, it will be appreciated by those skilled in the art that various combinations of features and capabilities may be incorporated into add-on modules for retrofitting existing fixed or variable weapons sights of any variety.

It will be understood that when an element or layer is referred to as being “on,” “connected to” or “coupled to” another element or layer, it can be directly on, connected or coupled to the other element or layer. Alternatively, intervening elements or layers may be present. In contrast, when an element is referred to as being “directly on,” “directly connected to” or “directly coupled to” another element or layer, there are no intervening elements or layers present.

Like numbers refer to like elements throughout. As used herein, the term “and/or” includes any and all combinations of one or more of the associated listed items.

It will be understood that, although the terms first, second, etc., may be used herein to describe various elements, components, regions, and/or sections, these elements, components, regions, and/or sections should not be limited by these terms. These terms are only used to distinguish one element, component, region, or section from another element, component, region, or section. Thus, a first element, component, region, or section discussed below could be termed a second element, component, region, or section without departing from the disclosure.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90° or at other orientations) and the spatially relative descriptors used herein interpreted accordingly.

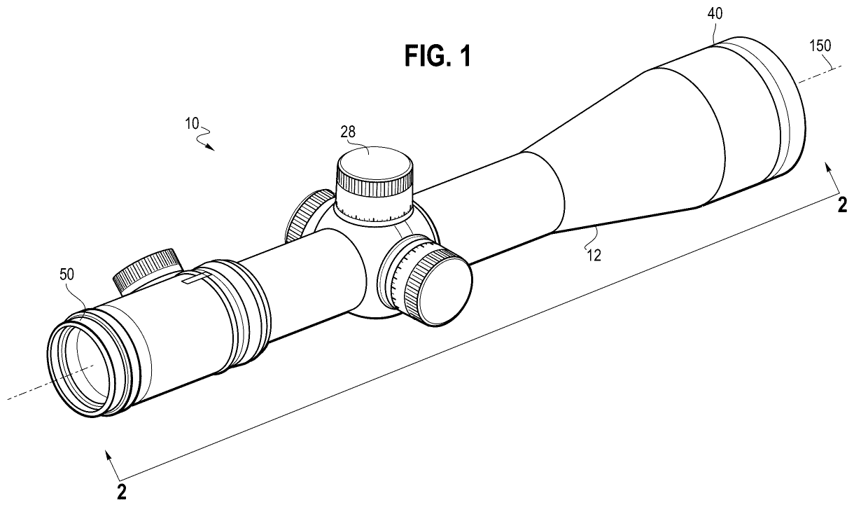

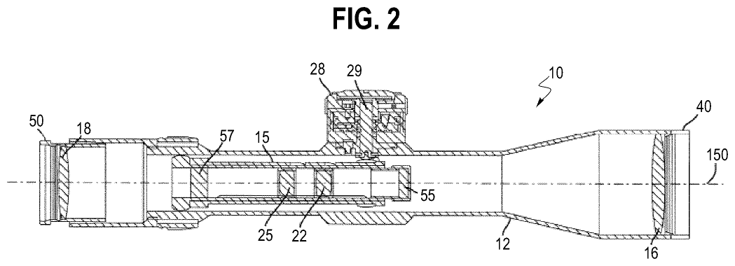

FIG. 1 shows an exemplary dual focal plane optical sighting device 10, having a scope body 12, objective lens end 40 and eyepiece end 50. FIG. 2 shows a cross-section of the sighting device from FIG. 1 showing the basic components of the optical system 14 and moveable optical element 15. As shown in FIG. 2, optical system 14 includes an objective lens system 16, erector system 25, and eyepiece 18. FIG. 2 shows a riflescope embodiment of the disclosure having a body 12, but optical system 14 could be used in other types of sighting devices as well. Erector system 25 may be included within a moveable optic element 15. In FIG. 2, moveable optic element 15 also includes a collector 22, as well as first focal plane reticle 55 and second focal plane reticle 57. When in use, adjustment of turret assembly 28 and turret screw 29 causes adjustment of moveable optic element 15.

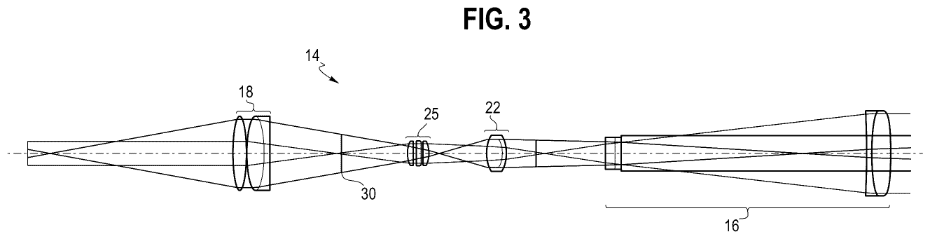

FIG. 3 shows a close-up view of an optical system 14 in cross-section, illustrating how light rays travel through the optical system 14. Optical system 14 may have additional optical components such as collector 22, and it is well known within the art that certain components, such as objective lens system 16, erector system 25, and eyepiece 18 may themselves have multiple components or lenses. Optical system 14 shown here is drawn as a basic system for illustration of one embodiment of the invention but it should be understood that variations of other optical systems with more or less structural components would be within the scope of the invention as well.

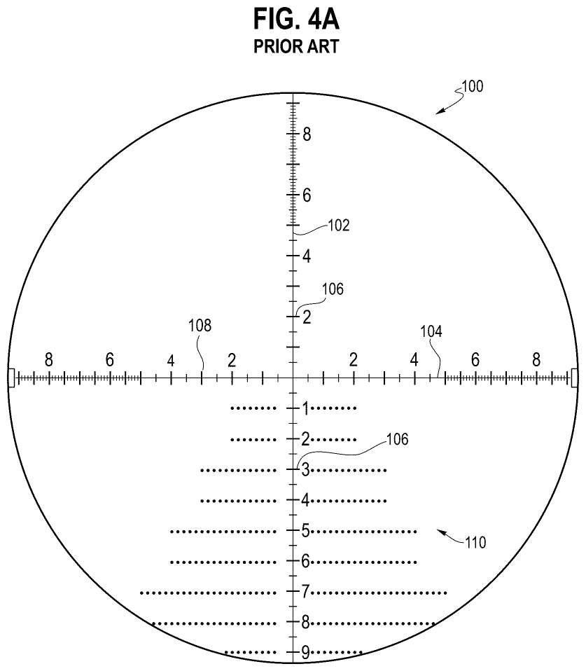

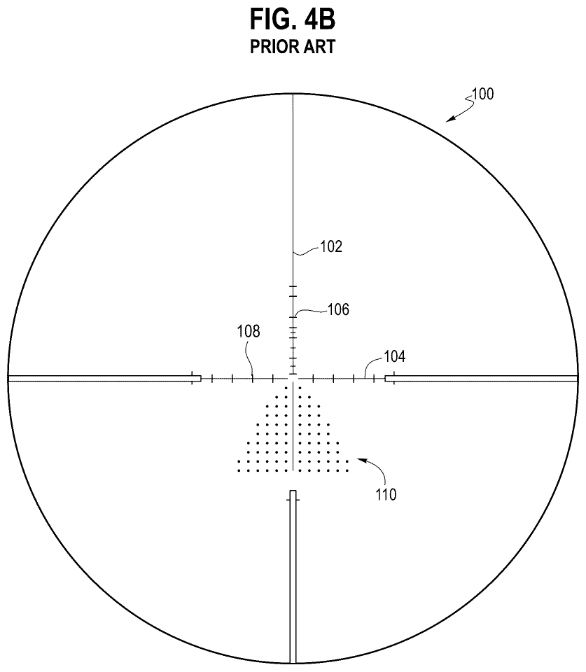

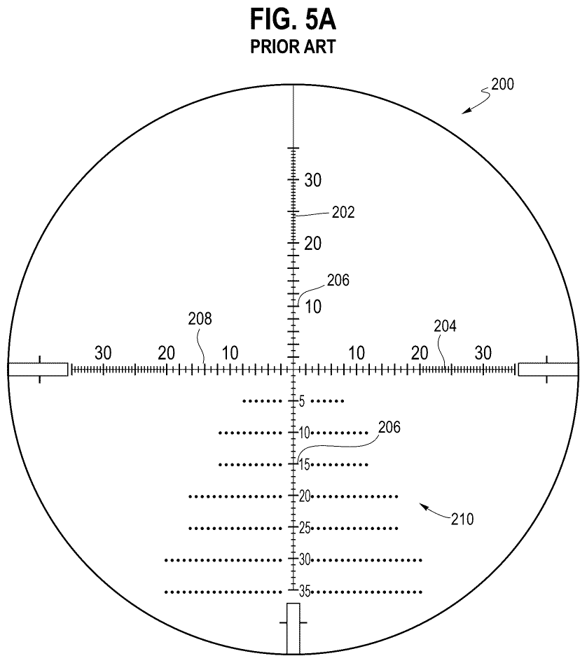

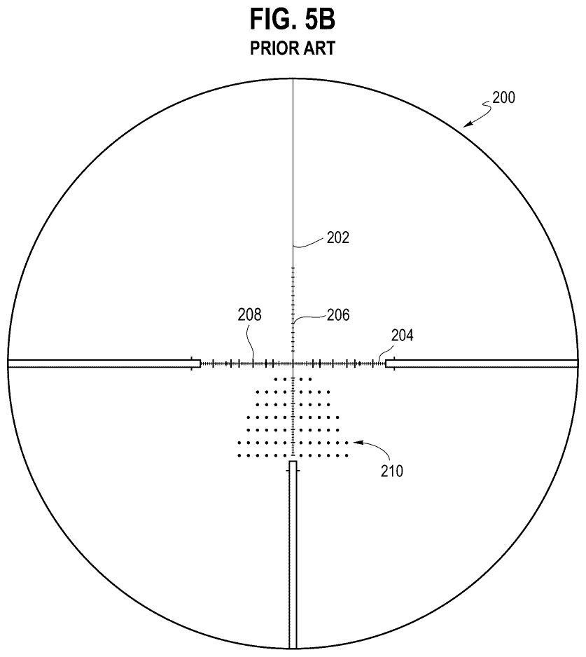

FIGS. 4A-5B are views through two very similar embodiments of prior art reticles. In particular, the reticle shown in FIGS. 4A and 4B show reticle similar to a Vortex Optics EBR-2C MRAD reticle 100, and FIGS. 5A and 5B show a reticle similar to a Vortex Optics EBR-2C MOA reticle 200 (collectively, the “EBR-2C Family”). The primary difference between the reticle 100 and reticle 200 is the unit of measure used for the subtension markings, which is selected per the shooter's preference. Although the embodiments shown use MRAD and/or MOA scales, any other suitable scale may be used without departing from the spirit of the disclosure. The EBR-2C Family includes a vertical stadia line 102, 202 and a horizontal stadia line 104, 204. Elevation subtension markings 106, 206 are provided along the vertical stadia line 102, 202. Similarly, windage subtension markings 108, 208 are provided along the horizontal stadia line 104, 204. The subtension markings 106, 206, 108, 208 provided in the EBR-2C Family are all of the same fine thickness, and all intersect either the vertical stadia line 102, 202 or the horizontal stadia line 104, 204. In addition, the lower half of each EBR-2C Family reticle includes a “Christmas tree” dot pattern 110, 210, which provides easy reference points away from the stadia lines 102, 202, 104, 204. Because each of the subtension markings 106, 206, 108, 208 intersects one of the stadia lines 102, 202, 104, 204, the EBR-2C Family of reticles is well suited for shooting at stationary targets, but lacks a more coarse set of subtension markings that would be ideal for moving targets.

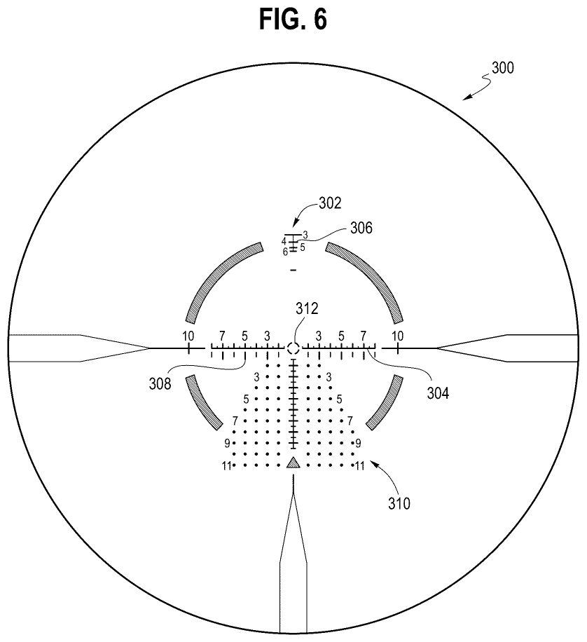

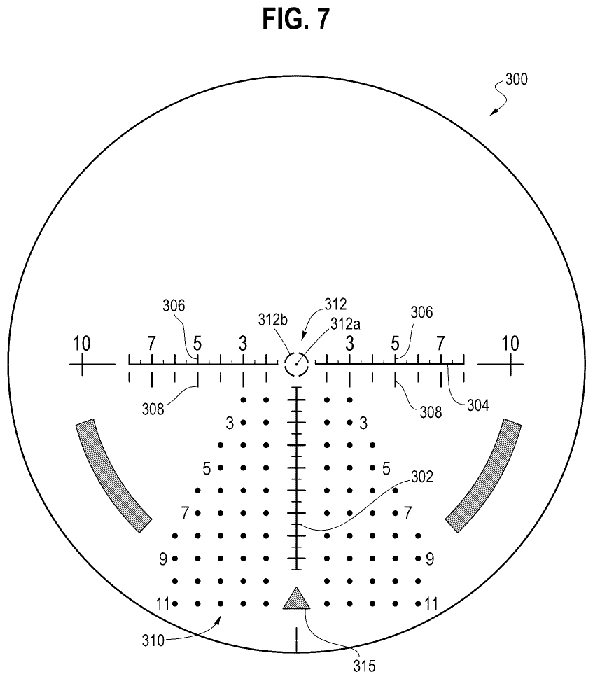

Turning now to FIGS. 6-7, one embodiment of a reticle 300 in accordance with the disclosure is shown. In the embodiment shown, reticle 300 is formed from a substantially flat disc or wafer formed from substantially transparent optical glass or other material suitable for manufacturing optical lenses. The disc has two, substantially parallel sides. A vertical stadia line 302, horizontal stadia line 304 and other markings are provided on one side or both sides of the disc using conventional methods such as, for example, etching, printing, engraved by a machine or burned by laser, or applying hairs or wires of known diameter. In a preferred embodiment, the vertical stadia line 302, horizontal stadia line 304 and other markings are provide on the disc using etching, engraving by a machine, or burning by a laser.

In the embodiments shown in FIGS. 6-7, the vertical stadia line 302 and horizontal stadia line 304 are discontinuous, meaning there are gaps in the respective stadia lines 302, 304. In particular, and with reference to FIGS. 6-7, the stadia lines 302 and 304 do not proceed across the entire viewing area of the reticle 300. Rather, the vertical stadia line 302 and horizontal stadia line 304 are formed with enough continuity to create the impression of a single line proceeding across a diameter of the reticle 300. Further, in the embodiments shown in FIGS. 6-7, the vertical and horizontal stadia lines 302, 304 do not actually intersect. Rather, and with specific reference to FIGS. 6-7, the vertical stadia line 302 and horizontal stadia line 304 stop prior to their intersection and resume after the projected intersection point, which in the embodiment shown, is the optical center.

Vertical stadia line 302 and horizontal stadia line 304 each bisect the reticle 300 to form four sectors: an upper right sector (e.g., quadrant), an upper left sector, a lower left sector, and a lower right sector. While in the embodiments shown the lines created by the vertical stadia line 302 and horizontal stadia line 304 visually intersect at the optical center of the reticle 300, it is contemplated that in other embodiments the lines created by the vertical stadia line 302 and horizontal stadia line 304 may intersect in an off-center location relative to the optical center of the reticle.

As shown in FIGS. 6-7, an aiming dot 312 is provided at the optical center of the reticle and/or location where the vertical stadia line 302 and horizontal stadia line 304 would intersect if not discontinuous. The aiming dot 312 can, for example, be included as an aid for rapid acquisition of moving targets and/or for centering a user's eye in the field of view of the viewing optic. The aiming dot 312 can be any shape, geometry, size or configuration. For example, in the embodiment shown, the aiming dot 312 has a generally solid circular middle point 312a with a discontinuous ring 312b encircling the middle point 312a. However, in other embodiments, the aiming dot 312 can be square, rectangular, oval, triangular, solid, translucent, solid, hollow and any combination of these features. The aiming dot 312 can be a predetermined size that covers a predetermined area of a target at a given range according to a scaling of the reticle 300.

Reticle 300 includes units shown in MRAD and includes vertical stadia line 302 and horizontal stadia line 304. Although the scale used for reticle 300 is MRADs, it will be appreciated that a similar reticle using MOA for its scale, or other scales, can be provided.

Reticle 300 also includes a “Christmas tree” dot pattern 310 on the lower half of the reticle. Reticle 300 provides information that includes subtension markings that aid shooters aiming at both stationary and moving targets, especially when the shooter wants to dial for elevation along vertical stadia line 302, but hold for wind along horizontal stadia line 304. In particular, fine subtension markings 306 may be used for aiming at stationary targets and is shown with a fine scale showing 0.2 MRAD increments. Fine subtension markings 306 are connected to the horizontal stadia line 304 to provide multiple fine aiming points along the horizontal axis. Coarse subtension markings 308 are located below horizontal stadia line 304 and are thicker than fine subtension markings 306. Coarse subtension markings 308 are thicker to allow the shooter's eye to pick them up more quickly when tracking a moving target, especially at a lower magnification setting.

FIG. 7 shows the view through reticle 300 in a lower magnification setting where coarse subtension markings 308 are more easily viewed than fine subtension markings 306. In addition, coarse subtension markings 308 are disconnected from the horizontal stadia line 304 and are shown with a coarse scale showing 0.5 MRAD subtension markings. The coarse subtension markings 308 are disconnected from the horizontal stadia line 304 to allow the fine intersected aiming points of the fine subtension markings 306 to be unobstructed for fine windage aiming points on the top of the horizontal stadia line 304. The intersected aiming points are not necessary for the relatively coarse aiming required for moving targets. Although the fine subtension markings 306 are shown above the horizontal stadia line 304 and the coarse subtension markings 308 are shown below the horizontal stadia line 304, the fine subtension markings may alternatively be located below the horizontal stadia line and the coarse subtension markings may alternatively be located above the horizontal stadia line.

Another advantage of reticle 300 is that the combination of fine subtension markings 306 and coarse subtension markings 308 enhance the readability of both sets of subtension markings that use different scales. For example, in reticle 300, the fine subtension markings 306 are shown in 0.2 MRAD increments and the coarse subtension markings 308 in shown in 0.5 MRAD increments. It is sometimes difficult to quickly determine the marking the shooter is looking at. The inclusion of a different scale on the bottom actually helps with the determination process.

In reticle 300, it is easy to determine the 0.4 and 0.6 fine subtension markings above the horizontal stadia line 304 because they are to the immediate right and left of the 0.5 coarse subtension markings 308. Of course, any other suitable scales may also be used with similar effect without departing from the invention.

Reticle 300 also includes hold point feature 315. The hold point feature 315 is located within the Christmas tree dot pattern 310 near the lower portion of the Christmas tree dot pattern 310. By positioning the hold point feature 315 within the lower portion of the Christmas tree dot pattern 310, the hold point feature 315 is readily usable when operating at low magnification settings, such as, for example, in close quarters situations, and also does not interfere when the Christmas tree dot patter 310 in longer range situations or higher magnifications. For example, at low magnifications, e.g., 1× or 2× magnification, the hold point feature 315 is readily in the field of vision and can be used as a quick hold point. In an embodiment, the hold point feature 315 is used as a 5-yard hold point to get on target when the optical sighting device is used at low, e.g., 1× or 2× magnification. If zoomed in on the hold point feature 315, the hold point feature 315 can offer hold points for ranges at 900 yards. In other words, the hold point feature 315 is positioned such that it is quickly visible at all magnifications but does not interfere with the Christmas tree dot pattern 310.

While the hold point feature 315 is described herein as being a triangle, it is understood that any shape, geometry or configuration can be used, e.g., square, rectangle, circle, oval, etc. Likewise, in the embodiments shown the hold point feature 315 is shown as a solid translucent feature, while in other embodiments the hold point feature 315 can be an outline, a solid dark feature, or have other coloring or fill.

The reticles disclosed herein are located in the first focal plane. With reference to FIG. 2, the reticles described herein are first focal plane reticles 55. When magnification is increased or decreased, the markings on the reticle increase or decrease in size relative to the target and subtension remains constant. As such, all features on the reticle remain accurate at any magnification.

All publications and patents mentioned in the above specification are herein incorporated by reference. Various modifications and variations of the described compositions and methods of the invention will be apparent to those skilled in the art without departing from the scope and spirit of the invention. One skilled in the art will recognize at once that it would be possible to construct the present invention from a variety of materials and in a variety of different ways. Although the invention has been described in connection with specific preferred embodiments, it should be understood that the invention should not be unduly limited to such specific embodiments. While the preferred embodiments have been described in detail, and shown in the accompanying drawings, it will be evident that various further modification are possible without departing from the scope of the invention as set forth in the appended claims. Indeed, various modifications of the described modes for carrying out the invention which are obvious to those skilled in marksmanship, computers or related fields are intended to be within the scope of the following claims.

What is claimed is:

1. A reticle comprising:
a horizontal stadia line and a vertical stadia line;
a plurality of elevation subtension markings having a thickness and are connected to the vertical stadia line;
a plurality of fine subtension markings positioned along the horizontal stadia line and having a thickness;
a plurality of coarse subtension markings positioned along the horizontal stadia line and having a thickness greater than the thickness of the fine subtension markings;
a Christmas tree dot pattern below the horizontal stadia line; and
a hold point feature within the Christmas tree dot pattern at a lower portion of the Christmas tree dot pattern.

2. The reticle of claim 1, wherein the hold point feature is triangular.

3. The reticle of claim 1, wherein the horizontal stadia line and the vertical stadia line are discontinuous.

4. The reticle of claim 3, further comprising an aiming dot at the optical center of the reticle.

5. The reticle of claim 1, wherein the reticle is glass and the horizontal stadia line, the vertical stadia line, the plurality of elevation subtension markings connected to the vertical stadia line, the plurality of fine subtension markings positioned along the horizontal stadia, the plurality of coarse subtension markings positioned along the horizontal stadia, the Christmas tree dot pattern, and the hold point feature are each etched onto a surface of the glass.

6. An optical sighting device comprising:
a body with a first end and a second end and having a center axis;
an objective lens system disposed within the body;
an erector lens system disposed within the body; the objective lens system, eyepiece lens, and erector lens system forming an optical system having a first focal plane and a second focal plane, the first focal plane proximate the objective lens system and the second focal plane proximate the eyepiece lens;
a first reticle at the first focal plane;
the first reticle including a horizontal stadia line and a vertical stadia line;
the first reticle further including a plurality of elevation subtension markings having a thickness and are connected to the vertical stadia line;
the first reticle further including a plurality of fine subtension markings positioned along the horizontal stadia line and having a thickness;
the first reticle further including a plurality of coarse subtension markings positioned along the horizontal stadia line and having a thickness greater than the thickness of the fine subtension markings;
the first reticle further comprising a Christmas tree dot pattern below the horizontal stadia line; and
the first reticle further comprising a hold point feature within the Christmas tree dot pattern at a lower portion of the Christmas tree dot pattern.

7. The optical sighting device of claim 6, wherein the hold point feature is triangular.

8. The optical sighting device of claim 6, wherein the horizontal stadia line and the vertical stadia line are discontinuous.

9. The optical sighting device of claim 8, further comprising an aiming dot at the optical center of the reticle.

10. The optical sighting device of claim 6, wherein the reticle is glass and the horizontal stadia line, the vertical stadia line, the plurality of elevation subtension markings connected to the vertical stadia line, the plurality of fine subtension markings positioned along the horizontal stadia, the plurality of coarse subtension markings positioned along the horizontal stadia, the Christmas tree dot pattern, and the hold point feature are each etched onto a surface of the glass.

11. The optical sighting device of claim 6, wherein the optical sighting device has a magnification range from 1× to 8×.

12. The optical sighting device of claim 6, wherein the optical sighting device has a magnification range from 1× to 10×.

13. A reticle comprising:
a horizontal stadia line and a vertical stadia line, wherein the horizontal stadia line and the vertical stadia line do no intersect one another;
a Christmas tree dot pattern below the horizontal stadia line; and
a hold point feature within the Christmas tree dot pattern at a lower portion of the Christmas tree dot pattern.
